(19) United States
(12) Patent Application Publication
(10) Pub. No.: US 2022/0035496 A1
(43) Pub. Date: Feb. 3, 2022

(54) USER INTERFACE, VEHICLE HAVING THE USER INTERFACE, AND METHOD FOR CONTROLLING THE VEHICLE

(71) Applicants: HYUNDAI MOTOR COMPANY, Seoul (KR); KIA MOTORS CORPORATION, Seoul (KR)

(72) Inventor: Cheol Ho Lee, Bucheon-si (KR)

(21) Appl. No.: 17/091,548

(22) Filed: Nov. 6, 2020

(30) Foreign Application Priority Data
Jul. 31, 2020 (KR) 10-2020-0096282

(51) Int. Cl. G06F 3/0484; G06F 3/0488; G09G 5/02; E05F 15/00

(52) U.S. Cl. CPC G06F 3/0484; G06F 3/0488; G09G 5/02; E05F 15/00; B60J 7/043; G09G 2320/0666; G09G 2380/10; G09G 2354/00; G06F 2203/04803

(57) ABSTRACT

A vehicle includes an opening/closing device including one of a movable glass panel and a window; a display including a partial region in which a symbol image representing the movable glass panel or the window is displayed and a background region excluding the partial region; an input configured to receive a touch input; and a controller configured to recognize a location of a touch point on the input, recognize a movement time, a movement direction, and a movement distance, recognize the movable glass panel's or the window's closing degree information based on the recognized movement distance and the movement direction, change the display information of a background area on the display based on the recognized movable glass panel or the window closing degree information, and transmit the recognized movable glass panel or the window closing degree information to the opening/closing device; and a driver configured to open or close the opening/closing device based on a control command from the controller.

### CROSS-REFERENCE TO RELATED APPLICATION(S)

This application is based on and claims priority under 35 U.S.C. § 119 to Korean Patent Application No. 10-2020-0096282, filed on Jul. 31, 2020, the disclosure of which is incorporated by reference in its entirety.

### TECHNICAL FIELD

The present disclosure relates to a user interface for preventing a user's erroneous operation, a vehicle having the same, and a vehicle control method.

### BACKGROUND

A vehicle includes a cluster that displays vehicle information and driving functions such as vehicle speed, engine speed, fuel flow, and coolant. In addition to the basic driving function, the vehicle further includes additional functions for user convenience such as audio function, video function, navigation function, air conditioning control, seat control, and lighting control.

The vehicle further includes a user interface for receiving operation commands for various functions and outputting operation states of various functions, and such a user interface may be provided on the center fascia.

The user interface is a device that enables interaction between various devices provided in a vehicle and a user, and the user interface includes a physical user interface (PUI) and a graphic user interface (GUI).

A physical user interface (PUI) is a device that receives user commands through a physical method such as a keypad, remote control, and touch pad, and a graphic user interface (GUI) is a device that receives a user command by selecting an icon or menu displayed on a display.

The user can move the cursor by referring to menus, lists, icons, etc. displayed through the graphic user interface and select an item on which the cursor is located. In this case, the user may select an item to be selected by moving a cursor displayed on the graphic user interface by touching the touch panel.

If the touch panel is provided in the center fascia or around the driver, regardless of the intention of the driver (that is, the user), there is a problem in that at least one function for any one item is malfunctioned because one item is touched by the driver by the driver's movement.

### SUMMARY

In view of the above, an aspect of the present disclosure provides a user interface, a vehicle including thereof, and a controlling method thereof for manipulating whether the movable glass panel is opened or closed based on the movement time of the touch point.

In view of the above, the other aspect of the present disclosure provides a user interface, a vehicle including thereof, and a controlling method thereof for displaying whether the movable glass panel is opened or closed and the degree of opening in color.

In accordance with an aspect of the present disclosure, a user interface may include a communicator configured to perform communication with a movable glass panel; a display including a partial region in which a movable glass panel symbol image is displayed and a background region excluding the partial region; an input configured to receive a touch input; and a controller configured to recognize a location of a touch point touched on the input, recognize a movement time, a movement direction, and a movement distance corresponding to the location change of the recognized touch point, recognize the movable glass panel's closing degree information based on the recognized movement distance and the movement direction when the recognized movement time is more than a reference time, change the display information of a background area displayed on the display based on the recognized movable glass panel closing degree information, and control the communicator to transmit the recognized movable glass panel closing degree information to the movable glass panel.

The controller may be configured to divide the background area into a first background area and a second background area based on the recognized movable glass panel closing degree information, adjust the size of the first background area and the second background area based on the recognized movable glass panel closing degree information, and change color information of the first background area.

The controller may be configured to determine whether the movable glass panel is completely open based on the recognized movable glass panel closing degree, and change the color of the background area to a first color when it is determined that the movable glass panel is completely open.

The controller may be configured to determine whether the movable glass panel is completely closed based on the recognized movable glass panel closing degree, and change the color of the background area to a second color when it is determined that the movable glass panel is completely closed.

The controller may be configured to change the color of the background area corresponding to an error condition when the movable glass panel opening/closing information is not received from the movable glass panel.

The controller may be configured to change the display information of the movable glass panel symbol image in response to a state in which the movable glass panel is not completely open and closed and is jammed.

The controller may be configured to control the communicator to transmit a complete open command or a complete closing command based on the recognized movement direction when the recognized movement time is less than the reference time.

The controller may be configured to change the color of the background area to a first color when transmitting a complete open command to the movable glass panel, and change the color of the background area to a second color when transmitting a complete closing command to the movable glass panel.

The controller may be configured to acquire location information on which the movable glass panel symbol image will be displayed based on location information of the recognized touch point, control the display of the movable glass panel symbol image based on the obtained location information, and control the movable glass panel symbol image to be displayed at a reference location when a touch signal for the touch input is not received.

In accordance with an aspect of the present disclosure, a vehicle may include an opening/closing device including at least one of a movable glass panel; a display including a partial region in which a symbol image representing the movable glass panel is displayed and a background region excluding the partial region; an input configured to receive a touch input; and a controller configured to recognize a location of a touch point touched on the input, recognize a movement time, a movement direction, and a movement distance corresponding to the location change of the recognized touch point, recognize the movable glass panel's or the window's closing degree information based on the recognized movement distance and the movement direction when the recognized movement time is more than a reference time, change the display information of a background area displayed on the display based on the recognized movable glass panel closing degree information, and transmit the recognized movable glass panel closing degree information to the opening/closing device; and a driver configured to open or close the opening/closing device based on a control command from the controller.

The controller may be configured to divide the background area into a first background area and a second background area based on the recognized movable glass panel closing degree information, adjust the size of the first background area and the second background area based on the recognized movable glass panel closing degree information, and change color information of the first background area.

The controller may be configured to determine whether the movable glass panel is completely open based on the recognized movable glass panel closing degree, and change the color of the background area to a first color when it is determined that the movable glass panel is completely open.

The controller may be configured to determine whether the movable glass panel is completely closed based on the recognized movable glass panel closing degree, and change the color of the background area to a second color when it is determined that the movable glass panel is completely closed.

The controller may be configured to change the color of the background area to a color corresponding to an error condition when the open/closed information of the recognized opening/closing device is not received.

The controller may be configured to change the display information of the symbol image in response to a state in which the movable glass panel is not completely open and closed and is jammed.

The controller may be configured to transmit a complete open command or a complete closing command based on the recognized movement direction to the opening/closing device when the recognized movement time is less than the reference time.

The controller may be configured to change the color of the background area to a first color when transmitting a complete open command to the movable glass, and change the color of the background area to a second color when transmitting a complete closing command to the movable glass panel.

In accordance with an aspect of the present disclosure, a control method of a vehicle having a movable glass panel, the method may include recognizing a location of a touch point touched on an input; recognizing a movement time, a movement direction, and a movement distance corresponding to the location change of the recognized touch point; recognizing the movable glass panel's closing degree information based on the recognized movement distance and the movement direction when the recognized movement time is more than a reference time; controlling the movable glass panel's closing degree based on the movable glass panel's closing degree information; changing display information of a background area displayed on a display based on the recognized movable glass panel closing degree information, and controlling the movable glass panel to be completely open or completely closed based on the recognized movement direction when the recognized movement time is less than the reference time based on the recognized movable glass panel closing degree information.

The changing the display information of a background area may include changing the color of the background area to a first color when transmitting a complete open command to the movable glass panel, changing the color of the background area to a second color when transmitting a complete closing command to the movable glass panel, dividing the background area into a first background area and a second background area when the movable glass panel is partially closed, and adjusting the size of the first background area and the second background area based on the recognized movable glass panel closing degree information, and changing the color of the first background area to a third color.

The method may further include changing the display information of the movable glass panel symbol image in response to a state in which the movable glass panel is not completely open and closed and is jammed.

### BRIEF DESCRIPTION OF THE DRAWINGS

These and/or other aspects of the disclosure will become apparent and more readily appreciated from the following description of the exemplary embodiments, taken in conjunction with the accompanying drawings of which:

FIG. 1 is an exemplary diagram of a vehicle according to an embodiment.

FIG. 2 is a diagram illustrating a control configuration of a vehicle according to an exemplary embodiment.

FIG. 3 is a diagram illustrating an exemplary display of a user interface provided in a vehicle according to an exemplary embodiment.

FIG. 4A to 4E are exemplary diagrams of changing the display of a background area of a display of a user interface for a control command of a controller in a vehicle according to an exemplary embodiment.

FIG. 5A to 5D are exemplary diagrams illustrating a change in display of a sunroof symbol image of a display of a user interface for a control command of a controller in a vehicle according to an exemplary embodiment.

FIG. 6 is an exemplary view illustrating control and display of a sunroof corresponding to a foreign matter jamming of a sunroof provided in a vehicle according to an exemplary embodiment.

FIG. 7 is a flowchart illustrating a vehicle control according to an exemplary embodiment.

### DETAILED DESCRIPTION

Like reference numerals refer to like elements throughout. The present disclosure does not describe all elements of the exemplary embodiments, and overlaps between the general contents or the embodiments in the technical field to which the present invention belongs.

This specification does not describe all elements of the exemplary embodiments of the present disclosure and detailed descriptions on what are well known in the art or redundant descriptions on substantially the same configurations may be omitted. The term “part”, “module”, “member”, “block” used in the specification may be implemented in software or hardware, and a plurality of parts, a plurality of modules, a plurality of members, or a plurality of blocks may be embodied as one component, It is also possible that one part, one module, one member, or one block′ includes a plurality of components.

Throughout the specification, when an element is referred to as being “connected to” another element, it may be directly or indirectly connected to the other element and the “indirectly connected to” includes being connected to the other element via a wireless communication network.

In addition, when a part is said to “include” a certain component, this means that it may further include other components, except to exclude other components unless otherwise stated.

Throughout the specification, when a member is located “on” another member, this includes not only when one member is in contact with another member but also when another member exists between the two members. The terms first, second, etc. are used to distinguish one component from another component, and the component is not limited by the terms described above. Singular expressions include plural expressions unless the context clearly indicates an exception. In each step, the identification code is used for convenience of description, and the identification code does not describe the order of each step. Each of the steps may be performed out of the stated order unless the context clearly dictates the specific order.

Hereinafter, with reference to the accompanying drawings will be described the working principle and embodiments of the present invention.

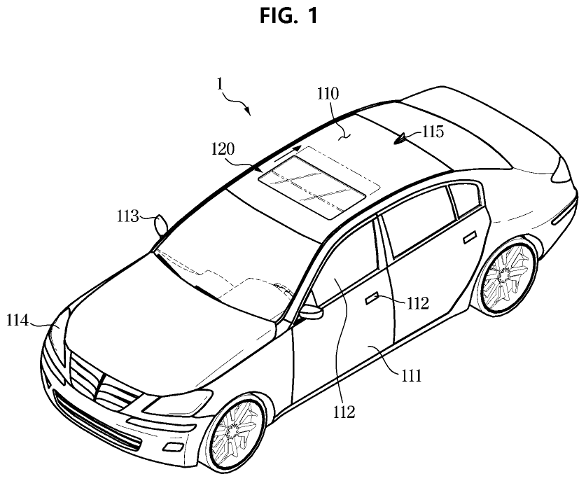

FIG. 1 is an exemplary diagram of a vehicle and a vehicle according to an embodiment.

The vehicle 1 includes a body having an interior and an exterior, and a chassis on which a mechanical device necessary for driving is installed in the rest of the body except for the vehicle body.

As shown in FIG. 1, the exterior of the vehicle body includes a front panel, a bonnet, a roof panel 110, a rear panel, a trunk in which luggage is loaded, a front and rear door 111, and a window 112 provided to be opened and closed on the front and rear doors 111.

The front, rear, left and right doors 111 may be provided with handles that a user can grasp to facilitate opening and closing of the door.

The exterior of the vehicle body includes a side mirror 113 that provides a driver with a view of the rear of the vehicle 1, and a plurality of lamps 114 that allow the driver to easily see information around the vehicle while looking at the front view.

The plurality of lamps 114 may perform not only a lighting function, but also a signal and communication function for other vehicles and pedestrians.

The vehicle may further include an antenna 115 for performing communication with a terminal and an external device. Here, the external device may include at least one of other vehicles, servers, and infrastructure.

The vehicle 1 is provided with the roof panel 110, and may further include a movable glass panel provided to open a partial area of the roof panel 110. An opening may be provided in a portion of the roof panel 110. A partial area of the roof panel 110 may be an area corresponding to the positions of the driver's seat and the passenger's seat among the areas of the roof panel.

A partial area of the roof panel 110 may include an area of a position corresponding to positions of a driver's seat and a passenger seat, and an area of a position corresponding to the position of a rear seat among the areas of the roof panel.

That is, the area of the sunroof may extend from an area corresponding to the positions of the driver's seat and the passenger seat among the areas of the roof panel to an area corresponding to the position of the rear seat.

The movable glass panel may include a sunroof 120 and a window.

The sunroof 120 may include a shielding panel provided in the opening of the roof panel, and may further include a sliding device that allows the shielding panel to move within the opening area, but to move in the form of sliding inside or outside the vehicle. Here, the shielding panel may include tempered glass.

The sunroof 120 allows the shielding panel to move within the open area, but may include an opening/closing control device for vertically moving, and it is also possible to include an opening/closing control device for rotating and moving in a tilt direction.

The sunroof 120 can be adjusted to allow outside light or air to enter the vehicle. Through this, the sunroof 120 facilitates internal lighting or ventilation of turbid air.

The sunroof 120 may be opened or closed in response to a user command, or may be opened to an opening degree corresponding to a user command. The window and the sunroof may be opening and closing devices capable of opening and closing.

The interior of the car body may include a seat on which the occupant sits, a dashboard, a cluster (i.e., instrument panel) arranged on the dashboard and guiding driving functions and vehicle information such as vehicle speed, engine speed, fuel flow, and coolant, and a center fascia on which the control panel of the air conditioner.

The seat is a chair on which the occupant can sit, and includes a driver's seat on which the driver sits, a passenger seat provided next to the driver's seat and seated by the occupant, and may further include a rear seat which is provided at the rear of the driver's seat and the passenger seat and in which the occupant can sit.

The vehicle is provided in the center fascia and may include a head unit for controlling an audio device, an air conditioner, a Bluetooth device, and a seat heating wire.

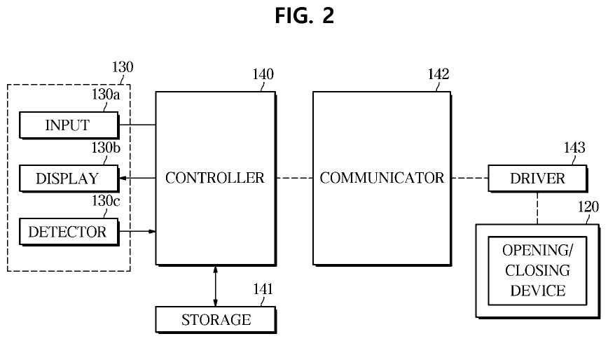

The center fascia head unit may be provided with a user interface 130 (see 130 in FIG. 2) that receives a user command and displays operation information of various functions or operation information of various electronic devices.

The user interface 130 may be provided with an input (refer to 130a of FIG. 2) for receiving a user command, and may include a display (see 130b of FIG. 2) that displays operation information on at least one of the functions performed in the vehicle and displays operation information on at least one of electronic devices provided in the vehicle.

The input (see 130a of FIG. 2) may include a hardware device such as various buttons or switches, pedals, keyboards, mice, track-balls, various levers, handles or sticks.

In addition, the input (refer to 130a of FIG. 2) may include a graphical user interface (GUI) such as a touch pad or a touch panel, that is, a device that includes software.

A display (see 130b of FIG. 2) may include a display panel.

Display panels include cathode ray tubes (CRT), digital light processing (DLP) panels, plasma display panels, liquid crystal display (LCD) panels, and electroluminescence (Electro Luminescence). EL) panel, Electrophoretic Display (EPD) panel, Electrochromic Display (ECD) panel, Light Emitting Diode (LED) panel, or Organic Light Emitting Diode (OLED) panel and the like, but is not limited thereto.

The input touch panel and the display panel of the display may be implemented as a touch screen panel (TSP). That is, the input touch panel can form a layer structure with the display panel of the display. In this case, the touch panel and the display panel may have the same shape and size, and the location information of the touch panel and the location information of the display panel may be identically matched to each other.

The user interface may recognize the location information of the touch panel as the location information of the display panel.

The touch panel is a transparent touch panel, allowing a user to visually identify an image displayed on the display panel by transmitting an image displayed on the display panel 130b disposed at the rear, and generates a touch signal corresponding to a touch position when a user's finger or an operator touches it.

Such a touch panel may be distinguished by a Resistive Type in which a metal electrode is formed on an upper or lower panel to determine the touched position as a voltage gradient according to resistance in a state where a DC voltage is applied, and an equipotential is formed on the conductive layer and applied to the touch, a Capacitive Type, which detects the location of the touched location by detecting the location where the voltage change of the upper and lower plates has occurred, and an electromagnetic induction method (Electro Magnetic Type) in which the touched position is sensed by reading the LC value induced when the operator (i.e., the electronic pen) touches the conductive film, and an Ultrasonic method (SAW Type, Surface Acoustic Wave Type), an Infrared Type, and a photo sensing method, etc. by depending on how the touch position is detected.

In addition, the input touch pad and the display panel of the display may be provided in different areas in the vehicle. That is, the input touch pad and the display panel of the display may be provided separately from each other. In this case, the touch information of the touch pad may be displayed as display information on the display panel. In this case, the touch pad and the display panel may have different shapes and different sizes. In addition, relative position information of the touch pad may be displayed on the display panel.

FIG. 2 is a diagram illustrating a control configuration of a vehicle according to an exemplary embodiment.

The vehicle 1 may include a user interface 130, a detector 130c, a controller 140, a storage 141, a communicator 142, and a driver 143.

The user interface 130 may include the input 130a for receiving user commands for various functions that can be performed in the vehicle 1, and the display 130b may display operation information on at least one of functions performed in the vehicle and display operation information on at least one of electronic devices provided in the vehicle.

The input 130a receives at least one of the plurality of windows 112 and the sunroof 120, an open command and a close command, and receives opening degree information on at least one of the plurality of windows 112 and sunroof 120.

The input 130a may receive a touch command from a user. The input 130a may generate a touch signal by a user's touch.

The user interface 130 may further include a detector 130c for detecting a touch signal.

The detector 130c may detect the touch signal generated from the input 130a, and detect the position of the touch point touched on the input 130a based on the detected touch signal, and also transmit information on the location of the detected touch point to the controller 140.

The detector 130c may detect the position of the touch point touched on the input 130a and transmit a signal for the detected position to the controller 140.

The detector 130c may include any one of a voltage sensor, a capacitive sensor, an electromagnetic inductive displacement sensor, an ultrasonic sensor, an infrared sensor, a photo sensor, and a pressure-sensitive sensor according to a method of recognizing a touch point touched on an input.

In response to the method of recognizing a touch point, the input may directly transmit a touch signal generated by a touch to the controller 140. In this case, the controller 140 may recognize the location of the touch point based on the received touch signal.

The display 130b may display information on various electronic devices and functions in the vehicle in response to a command from the controller.

The display 130b may display functions that can be performed in a vehicle or items for electronic devices that can be manipulated by a user as a symbol image.

For example, the display 130b may display items for audio, radio, broadcast, navigation, movie playback function, call function, etc. as icons, and may also display the item for the channel or volume change function as a symbol image.

The display 130b may display information on the lighting state and the light-off state of a plurality of lamps provided indoors as a symbol image.

The display 130b may display status information on current states of a plurality of doors, a plurality of windows, and a sunroof as an image.

For example, the display 130b may display information about the opening degree as an image for a locked/unlocked state of a plurality of doors, an open/closed state of a tailgate, an open/closed state of at least one of a plurality of windows, an open degree, an open/closed degree of a sunroof.

The display 130b may display status information on normal and error conditions of a plurality of windows and sunroofs as an image.

When at least one of the plurality of windows 112 and the sunroof 120 is in an error state, the display 130b may display error information as display information different from that in the normal state.

The display information may include at least one of color information, contrast information, saturation information, contrast information, and emoticon information.

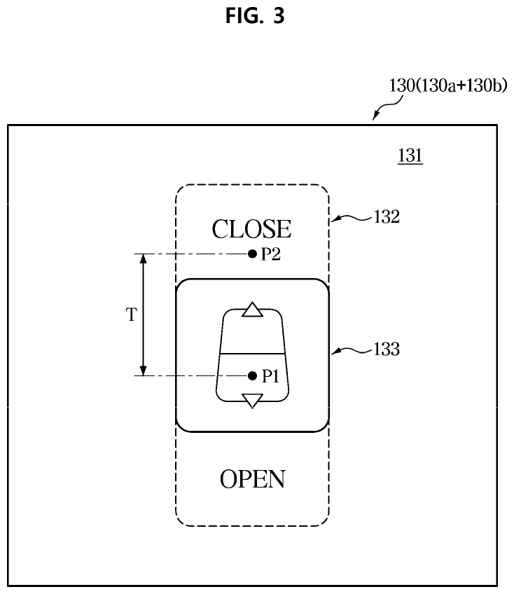

As shown in FIG. 3, the display 130b of the user interface displays a sunroof symbol image 133 corresponding to the sunroof in a partial area of the entire display area 131, and displays a moving area image 132 to which the sunroof symbol image 133 can move around the sunroof symbol image 133.

The moving area image 132 displayed on the display 130b of the user interface, may include two moving region images corresponding to a moving direction in which the sunroof symbol image 133 can move based on the reference position of the sunroof symbol image 133.

Text images of an open command (OPEN) and a close command (CLOSE) corresponding to the operation command of the sunroof may be displayed in the two moving area images for each movement direction.

In the entire display area 131 of the display 130b of the user interface, except for the sunroof symbol image 133 and the moving area image 132 in which the sunroof symbol image 133 is displayed, images of other functions or other electronic devices may be displayed.

The user interface may be a terminal (AVN) provided in a vehicle and performing audio, video, and navigation functions.

The controller 140 recognizes the location of the touch point based on the touch signal input to the input 130a.

The controller 140 may receive location information on the location of the touch point detected by the detector 130c and recognize the location of the touch point based on the received location information.

The controller 140 compares the location information of the recognized touch point with the location information of the pre-stored sunroof symbol image 133 to determine whether the location of the touch point and the location of the sunroof symbol image are the same. When it is determined that the location of the touch point is the same as the position of the sunroof symbol image, the controller 140 determines whether the recognized touch point has moved, and when it is determined that the recognized touch point has moved, the movement direction of the touch point and the movement time of the touch point are determined.

As shown in FIG. 3, the controller 140 recognizes the second position P2 changed by moving the touch point from the first position P1, which is the position of the sunroof symbol image, recognizes the movement time T moving from the first position P1 to the second position P2, and recognizes a moving direction from the first position P1 to the second position P2.

When recognizing the moving direction of the touch point and the moving time of the touch point, the controller 140 recognizes the movement direction and movement time of the touch point while the user's hand or the manipulator is not separated from the input.

Here, the movement direction of the touched point means the sliding direction, and the movement time means the sliding time. That is, the controller 140 may recognize the sliding direction and the sliding time of the touch point.

The controller 140 may determine whether the touch point has moved, that is, whether or not it slides by determining whether the position of the recognized touch point has changed.

When the recognized sliding time is more than the reference time, the controller 140 recognizes the user's touch intention as the intention for manual operation, and when the recognized sliding time is less than the reference time, the controller 140 may recognize the user's touch intention as a full open/close operation intention through one touch.

The controller 140 determines whether the sliding direction corresponding to the change in the position of the touch point is a first direction or a second direction, controls the closing degree of the sunroof when it is determined that the sliding direction is the first direction while the recognized sliding time is greater than or equal to the reference time, and controls the openness of the sunroof when it is determined that the sliding direction is the second direction while the recognized sliding time is greater than or equal to the reference time.

When controlling the open or closed degree of the sunroof, the controller 140 recognizes the sliding distance corresponding to the change in the position of the touch point and recognizes the degree of opening or closing of the sunroof corresponding to the recognized sliding distance.

The controller 140 may control the opening and closing of the sunroof based on the recognized degree of opening or closing of the sunroof, and controls the complete closing of the sunroof when it is determined that the sliding direction is the first direction while the recognized sliding time is less than the reference time, and controls the complete opening of the sunroof when it is determined that the sliding direction is the second direction while the recognized sliding time is less than the reference time.

The controller 140 may control a position at which the sunroof symbol image is displayed in response to a change in the position of the touch point.

When a touch signal is not received, the controller 140 displays a sunroof symbol image at a reference position.

The controller 140 may control the display so that display information of the background area of the display of the user interface is changed in response to a change in the position of the touch point. Here, the background area of the display may be an area excluding the sunroof symbol image and the image of the moving area.

The controller 140 may control the display to change display information of a background area of the display based on sliding information about a sliding time, a sliding direction, and a sliding distance.

The controller 140 may determine whether the sunroof has an error and control the display to display error information when it is determined that the sunroof is in an error state.

For example, when it is determined that the sunroof is in a faulty state, the controller 140 may control the display so that display information of the sunroof symbol image is changed.

The controller 140 controls the movement of the display position of the sunroof symbol image in response to the movement position of the touch point. That is, the controller 140 may acquire location information on which the sunroof symbol image is to be displayed based on the location information of the touch point, and control the display of the sunroof symbol image based on the acquired location information.

The controller 140 may stop and control the operation of the sunroof when it is determined that the location of the touch point is the same as the location of the sunroof symbol image for a predetermined time or longer.

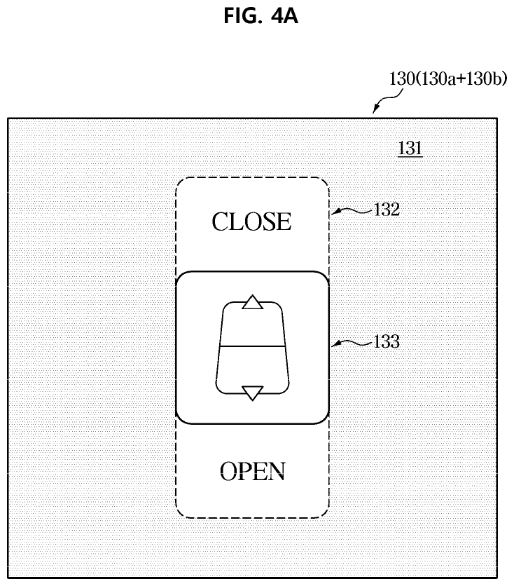

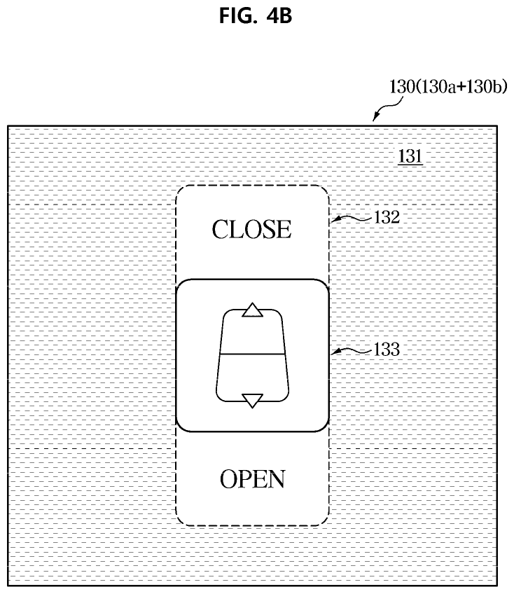

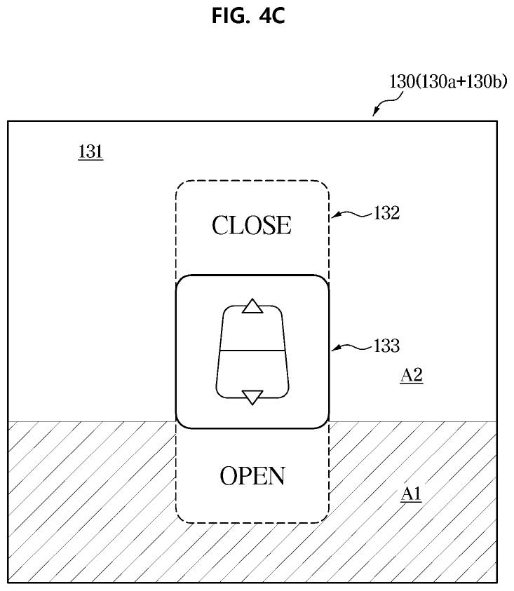

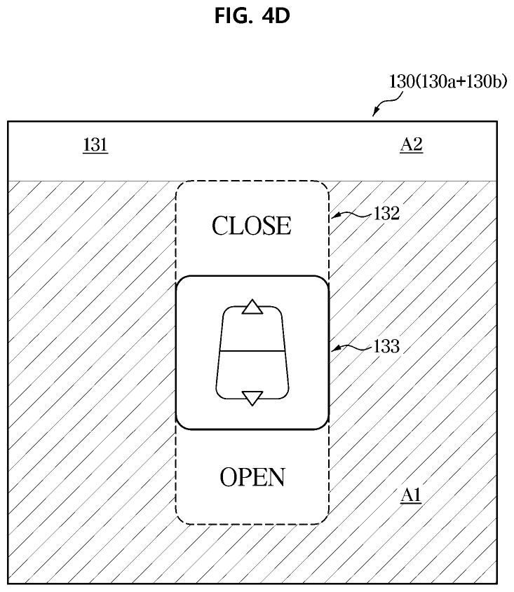

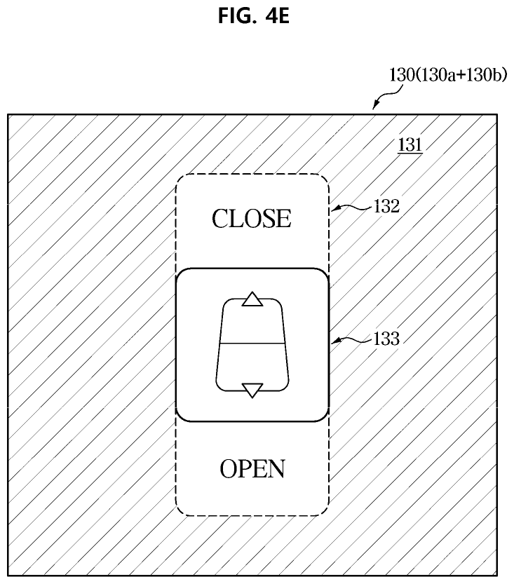

An example of changing the display of the background area of the display 130b in response to the control command of the controller 140 will be described with reference to FIGS. 4A to 4E.

The controller 140 receives the open/close information of the sunroof from the driver 143, recognizes the degree of opening/closing of the sunroof based on the received open/close information, and may change the display information of the background area of the display in response to the recognized open/closed degree. Here, the display information may include at least one of color information, contrast information, saturation information, contrast information, and emoticon information.

For example, as shown in FIG. 4A, the display 130b may display the background area 131 of the display in the first color when the sunroof is completely opened in response to a control command of the controller 140.

In addition, when it is determined that the sliding direction is the second direction while the recognized sliding time is less than the reference time, the controller may control the display so that the background area of the display is displayed in the first color.

As shown in FIG. 4B, the display 130b may display the background area 131 in the second color when the sunroof is completely closed in response to a control command of the controller 140.

In addition, when it is determined that the sliding direction is the first direction while the recognized sliding time is less than the reference time, the controller may control the display so that the background area of the display is displayed in the second color.

As shown in FIGS. 4C and 4D, when the sunroof is partially opened in response to the opening degree selected by the user in response to the control command of the controller 140, the display 130b divides the background area 131 into two areas (A1, A2), and displays the two areas (A1, A2) in different colors, that is, the 3rd and 4th colors, corresponding to the sunroof's opening degree.

In addition, among the background areas, the first background area A1 is an area showing the degree to which the sunroof is closed, and may increase in size as the closed degree of the sunroof increases.

The size of the first background area A1 may be determined according to a ratio of the closed degree of the sunroof to the total opening degree of the sunroof.

That is, the controller 140 divides the background area into two areas corresponding to the opening degree of the sunroof, but can adjust the size of the divided two areas corresponding to the opening degree.

In addition, the controller 140 divides the background area into two areas corresponding to the closed degree of the sunroof, but it is also possible to adjust the size of the divided two areas corresponding to the closed degree.

That is, the controller 140 may adjust the size of the first background area among the background areas in response to the opening or closed degree of the sunroof.

The display may display the first background area A1 adjusted according to the closed degree in a first color, and display the second background area A2 in a second color.

The display may display only the first background area A1 adjusted according to the closed degree in the first color, and maintain the second background area A2 as the background color.

As illustrated in FIG. 4E, the display 130b may display the background area 131 in a fifth color in response to an error state of the sunroof.

In this case, when the controller does not receive information on the opening or closed degree of the sunroof from the driver, the display can be controlled so that the background area of the display is displayed in the fifth color.

When information about the inability to check sunroof information is received from driver 143, the controller 140 may control the display so that the background area of the display is displayed in the fifth color.

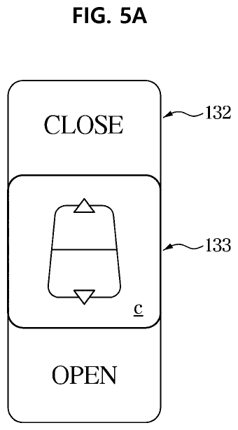

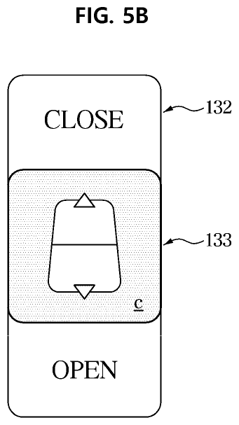

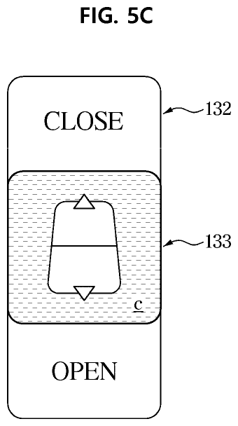

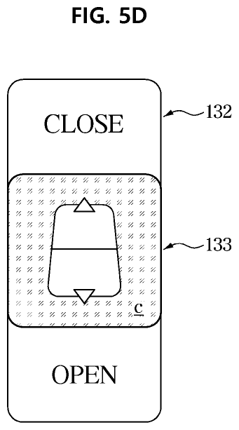

An example of changing the display of the sunroof symbol image of the display 130b in response to the control command of the controller 140 will be described with reference to FIGS. 5A to 5D.

As shown in FIG. 5A, when the sunroof is in a normal state, the display displays an area c constituting the sunroof symbol image in a sixth color.

As shown in FIG. 5B, when the one-touch manipulation of the sunroof is impossible, the display displays the area c forming the sunroof symbol image in a seventh color. The one-touch operation is for automatically completely open or automatically completely closed, and the state in which the one-touch operation is impossible includes a state in which an error such as initialization of the sunroof operation is cancelled.

As shown in FIG. 5C, when the display is completely open or completely closed by touching off in a state of sliding less than the reference time, the area c constituting the sunroof symbol image is displayed in an eighth color.

This allows the user to recognize that the user's intention has been recognized as a one-touch intention because the vehicle sliding has occurred but the sliding time is less than the reference time and the user's intention cannot be accurately determined.

As shown in FIG. 5D, when it is determined that the sunroof is jammed while the display is completely closed, the area c constituting the symbol image is displayed in the ninth color.

The display may display an area c constituting a symbol image by blinking.

When the error information of the sunroof is received from the driver 143, the controller 140 controls the complete opening of the sunroof, and may change display information displayed on the user interface in response to complete open control of the sunroof.

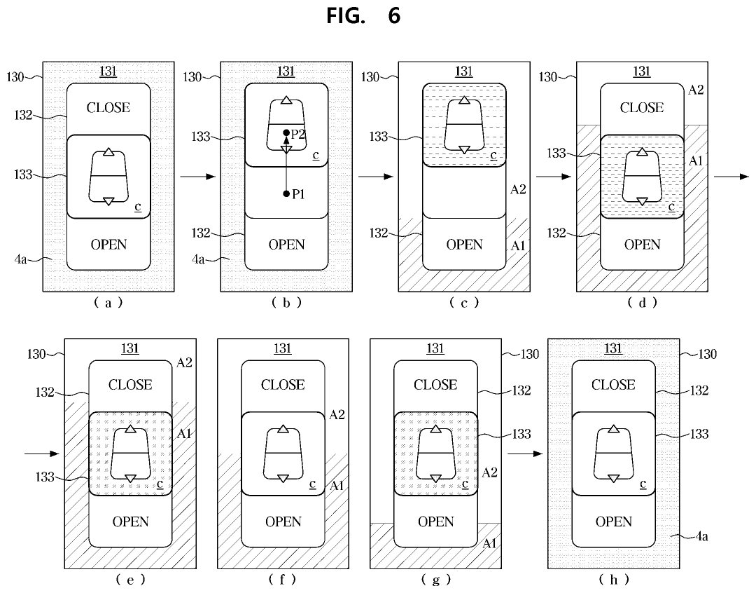

Here, the error information of the sunroof may include failure information of the sunroof due to foreign matter being caught. This will be described with reference to FIG. 6.

As shown in (a) of FIG. 6, the controller displays the background area 131 of the display in a first color when the sunroof is completely open, and the controller displays the sunroof symbol image in a sixth color.

As shown in (b) of FIG. 6, when a touch point is recognized, the controller recognizes a sliding time, a sliding distance, and a sliding direction corresponding to a position change of the touch point.

Because it is before information about the operating state of the sunroof is received from the driver, the controller 140 maintains the display of the first color of the background area 131 of the display and maintains and controls the color of the sunroof symbol image.

As shown in (c) in FIG. 6, the controller 140 transmits a complete closing command to the driver, and divides the background area of the display into two areas, displays the two areas in third and fourth colors, respectively, and displays the sunroof symbol image in an eighth color according to the closed degree of the sunroof.

As shown in (d) in FIG. 6, the controller 140 adjusts the size of the two areas of the background area of the display in response to the degree of progression of the sunroof closing, and displays the two areas in the third and fourth colors respectively, and displays the sunroof symbol image in the eighth color.

As shown in (e) in FIG. 6, the controller 140 displays the sunroof symbol image in a ninth color when an error information about the inability to close is received from the driver 143 in response to a complete closing command of the sunroof.

In addition, the driver generates error information and automatically opens the sunroof if the sunroof is not completely closed even though the sunroof is completely closed in response to the command to completely close the sunroof. In this case, the driver may transmit error information of the sunroof to the controller 140.

As shown in (f) and (g) of FIG. 6, the controller 140 receives the opening degree of the sunroof from the driver, divides the background region into two regions based on the received opening degree, and displays the two divided regions in third and fourth colors.

The controller 140 may control the blinking of the sunroof symbol image.

As shown in (h) of FIG. 6, when the information about the complete opening of the sunroof is received, the controller 140 displays the background area of the display in a first color so that the user recognizes that the sunroof is completely opened.

When it is determined that the sunroof is in a normal state with the foreign matter removed from the sunroof, the sunroof symbol image is displayed in a fifth color.

The controller 140 can also be implemented with one processor.

The controller 140 may be implemented by a memory (not shown) such as a non-transitory computer-readable medium that stores an algorithm for controlling the operation of the components in the user interface or a program that reproduces the algorithm, and a processor (not shown) that performs the above-described operation when executing the algorithm stored in the memory. In this case, the memory and the processor may be implemented as separate chips, respectively. Alternatively, the memory and processor may be implemented as a single chip.

The controller 140 may be a controller that performs overall control of vehicle driving.

The controller 140 may control the communicator 142 to transmit and receive information between various electronic devices provided in the vehicle, and the controller 140 may control the communicator 142 to transmit and receive information between various controllers provided in the vehicle.

The storage 141 may store location information of symbol images displayed on the user interface.

That is, the storage 141 may store location information of a sunroof symbol image and location information of two moving areas.

The storage 141 may store information on a reference time for recognizing a user's touch intention.

The storage 141 stores information on the operation command of the sunroof corresponding to the movement area for each movement direction.

The storage 141 may store information on a closed degree corresponding to the sliding distance and an open degree corresponding to the sliding distance.

The storage 141 may store information on a division ratio of a background area corresponding to an opening degree of the sunroof, and store color information on completely open and completely closed.

The storage 141 may store color information corresponding to the first background area and the second background area constituting the background area.

The storage 141 may store color information of a sunroof symbol image corresponding to an operation state of the sunroof.

The storage 141 may store color information corresponding to an error state of the sunroof.

The storage 141 may be implemented with at least one of a Nonvolatile memory devices such as cache, Read Only Memory (ROM), Programmable ROM (PROM), Erasable Programmable ROM (EPROM), Electrically Erasable Programmable ROM (EEPROM), and Flash memory, or a volatile memory device such as random access memory (RAM), or a storage medium such as a hard disk drive (HDD, Hard Disk Drive) or CD-ROM, but is not limited thereto.

The storage 141 may be a memory implemented as a separate chip from the processor described above with respect to the controller 140, or may be implemented as a processor and a single chip.

The communicator 142 transmits and receives information or signals between the controller 140 and the driver 143.

The communicator 142 may transmit a control signal generated by the controller 140 to the driver 143 in response to a control command to the controller 140, and may transmit operation information regarding an opening/closing operation of the sunroof transmitted from the driver 143 to the controller 140.

The communicator 142 may include one or more constituent elements that enable communication between vehicle internal constituent elements, and for example, may include at least one of a short-range communication module, a wired communication module, and a wireless communication module.

The short-range communication module may include various short-range communication modules that transmit and receive signals using a wireless communication network in a short range, such as Bluetooth module, infrared communication module, RFID (Radio Frequency Identification) communication module, WLAN (Wireless Local Access Network) communication module, NFC (Near Field Communication) module, Zigbee communication module, etc.

The Wired communication module includes not only various wired communication modules such as controller area network (CAN) communication module, local area network (LAN) module, wide area network (WAN) module, or value added network (VAN) module, etc., but also various cable communication modules such as Universal Serial Bus (USB), High Definition Multimedia Interface (HDMI), Digital Visual Interface (DVI), recommended standard 232 (RS-232), power line communication, or plain old telephone service (POTS), etc.

The wired communication module may further include a local interconnect network (LIN).

In addition to the WiFi module and the wireless broadband module, the wireless communication module may include a wireless communication module supporting various wireless communication methods such as Global System for Mobile Communication (GSM), Code Division Multiple Access (CDMA), Wideband Code Division Multiple Access (WCDMA), universal mobile telecommunications system (UMTS), Time Division Multiple Access (TDMA), Long Term Evolution (LTE), seconds Broadband communication (UWB: Ultra Wide Band) module, etc.

The wireless communication module may further include a wireless charging module that communicates with a Wireless Power Consortium (WPC) standard to wirelessly charge the terminal. The wireless charging module of the WPC standard can allow the terminal to be charged in a magnetic induction method.

The driver 143 drives the sliding device of the sunroof or the opening/closing control device in response to a control command of the controller 140 to open or close the sunroof.

The driver 143 may adjust the opening degree or the closing degree of the sunroof by driving the sliding device or the opening/closing control device of the sunroof in response to a control command of the controller 140.

Here, the opening/closing control device may move the shielding panel of the sunroof, and may keep the sunroof in a closed state or maintain an open state.

The driver 143 may be a microprocessor, a CPU, or a processor.

The driver 143 may be implemented by a memory (not shown) such as a non-transitory computer-readable medium that stores an algorithm for controlling the operation of the components in the sunroof or a program that reproduces the algorithm, and a processor (not shown) that performs the above-described operation when executing the algorithm or the program stored in the memory. In this case, the memory and the processor may be implemented as separate chips, respectively. Alternatively, the memory and processor may be implemented as a single chip.

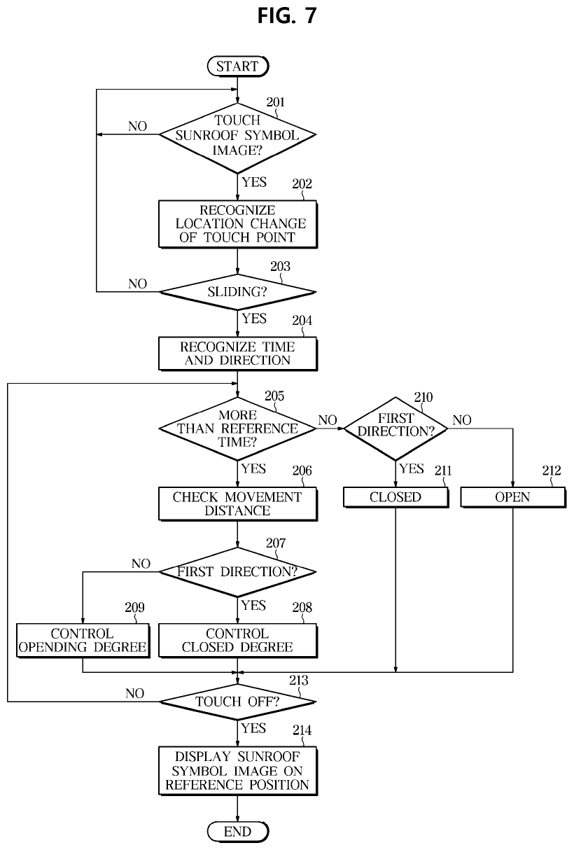

In this case, the vehicle may recognize the location of the touch point touched on the input and recognize the opening/closing device displayed at the location of the recognized touch point. FIG. 7 is a flowchart illustrating a vehicle control according to an exemplary embodiment.

When it is determined that the user interface is touched, the vehicle recognizes the location information of the touched point based on the touch signal generated at the time of the touch. The vehicle compares the location information of the recognized touch point with the location information of the sunroof symbol image to determine whether the location of the identified touch point is the location of the sunroof symbol image. That is, the vehicle determines whether the sunroof symbol image displayed on the user interface is touched (201).

The vehicle determines whether the location of the touch point and the location of the sunroof symbol image are the same, and when it is determined that the location of the touch point is the same as the location of the sunroof symbol image, it recognizes whether the location of the recognized touch point changes (202). At this time, the vehicle recognizes whether the position of the touch point changes in a state in which the user's hand or the operating body is not separated from the input (i.e., the touch panel), that is, in a state where the touch is maintained.

Here, the state in which the user's hand or the operator is not separated from the input (i.e., the touch panel) includes a state in which a touch-off signal is not received or a state in which a touch-on signal is continuously received.

The vehicle determines whether the touch point slides based on the recognition of the position change of the touch point (203). That is, when it is determined that the location of the touch point has changed, the vehicle determines that it is in a sliding state, and when it is determined that the location of the touch point is the same, it determines that it is in a stopped state.

If the vehicle determines that the location of the touch point is the same even though the time has changed, it may be determined as a user's error and may not perform sunroof control.

When it is determined that the touch point is in a sliding state, the vehicle recognizes the sliding direction and the sliding time. That is, the vehicle recognizes a change in the location of the touch point while the touch is being made, and recognizes the time and direction in which the touch point moved based on the changed location information.

The vehicle determines whether the recognized sliding time is more than the reference time (205), and when it is determined that the recognized sliding time is more than the reference time, the user's touch intention is recognized as the intention for manual operation, and when it is determined that the recognized sliding time is less than the reference time, the user's touch intention may be recognized as a full open/close operation intention through one touch.

When the vehicle determines that the recognized sliding time is greater than or equal to the reference time, the vehicle recognizes the user's intention to touch as the intention for manual manipulation, and checks the distance the touch point has moved (206). Here, the distance that the touch point has moved may be a sliding distance.

The vehicle determines whether the recognized sliding direction is the first direction (207), and when it is determined that the sliding direction is the first direction, it is recognized that the user's intention is to close the sunroof by manual, and checks the closed degree corresponding to the recognized distance traveled, and controls the closing of the sunroof based on the confirmed closed degree so that the closed degree of the sunroof of the identified movement distance is adjusted (208).

Here, the closed degree may be the degree to which the sunroof is closed, and may be a closing distance when the tempered glass of the sunroof moves in the direction to close the opening.

The vehicle may change background information displayed on the user interface in response to the closed degree.

If the vehicle determines that the recognized sliding direction is not the first direction, the vehicle determines whether the sliding direction is the second direction, and when the vehicle determines that the sliding direction is the second direction, it recognizes that the user's intention is to open the sunroof by the manual, checks the degree of opening corresponding to the recognized movement distance, controls the closing of the sunroof based on the confirmed degree of opening, so that the degree of opening of the sunroof is adjusted to the identified opening degree (209).

Here, the opening degree may be the degree to which the sunroof is opened, and may be an opening distance when the tempered glass of the sunroof moves in a direction to open the opening.

The first direction may be a direction in which the closing command is directed toward the first moving area indicated by text, and the second direction may be a direction in which the open command is directed toward the second moving area indicated by text.

The vehicle may change background information displayed on the user interface according to the opening degree.

When it is determined that the recognized sliding time is less than the reference time, the vehicle determines whether the recognized sliding direction is the first direction (210), and when it is determined that the sliding direction is the first direction, the user's intention is to recognize that the sunroof is closed by one-touch, and the sunroof is automatically closed (211). At this time, the vehicle moves the tempered glass so that the opening is completely closed. That is, the vehicle allows the sunroof to be completely closed.

When the opening is completely closed, it means that the degree of opening is zero.

The vehicle can change the background information displayed on the user interface in response to the complete closure of the sunroof.

When the vehicle determines that the recognized sliding direction is not the first direction, it determines whether the sliding direction is the second direction, and when it is determined that the sliding direction is the second direction, it is recognized that the user's intention is to open the sunroof by one-touch, and the sunroof is automatically opened (212).

At this time, the vehicle moves the tempered glass so that the opening is opened entirely.

That is, the vehicle allows the sunroof to be completely opened.

When the opening is completely open, it means that the closed degree is zero.

The vehicle can change the background information displayed on the user interface in response to the complete opening of the sunroof.

When recognizing the sliding direction, the sliding time, and the sliding distance, the user's hand or an operating object may be in a touched state or a state in which it does not move. In this case, when the vehicle determines that the touch-off signal has been received in the user interface (213), the sunroof symbol image is displayed at a reference position (214).

Determining that the touch-off signal has been received may include determining that the touch signal is no longer received.

In addition, it is possible for the vehicle to control the sunroof by recognizing whether or not to slide and the sliding time and direction in a state in which the user's hand or the operator's touch is off.

In the present embodiment, the opening and closing of the sunroof and the image display corresponding to the opening and closing of the sunroof have been described as an example, but it can also be implemented to control the opening and closing of the window 112 and the image display corresponding to the opening and closing of the window. That is, the present embodiment can control the opening and closing of the opening and closing device and the image display corresponding to the opening and closing of the opening and closing device.

In addition, the sunroof symbol image may be changed to a control target symbol image for controlling opening and closing. For example, when the user tries to open and close the window, it can control the opening and closing of the window by touching and moving the window symbol image displayed on the user interface.

Meanwhile, the disclosed embodiments may be implemented in the form of a recording medium storing an instruction executable by a computer. The instruction may be stored in the form of a program code, and when executed by a processor, a program module may be generated to perform operations of the disclosed embodiments. The recording medium may be implemented as a computer-readable recording medium.

The non-transitory computer-readable recording medium includes all types of recording media storing data readable by a computer system. Examples of the computer-readable recording medium include a Read Only Memory (ROM), a Random Access Memory (RAM), a magnetic tape, a magnetic disk, a flash memory, an optical data storage device, or the like.

Although a few exemplary embodiments of the present disclosure have been shown and described, it would be appreciated by those skilled in the art that changes may be made in these exemplary embodiments without departing from the principles and spirit of the disclosure, the scope of which is defined in the claims and their equivalents.

In accordance with an aspect of the present disclosure, it may be possible to faithfully reflect the user's will in controlling the sunroof and window by controlling whether or not to open and close the sunroof or window based on the moving time of the touch point.

According to the present exemplary embodiment, the present embodiment may prevent safety accidents that may occur due to manipulation by an unintended user. Also, the present embodiment may enhance the marketability of a touch panel for operating a sunroof and a window provided in a vehicle.

As described above, according to the present exemplary embodiment, manual and one-touch operations can be implemented by classifying operation logic according to manipulation of a touch panel.

According to the present exemplary invention, a user's recognition degree can be improved by changing a background color of a user interface or a color of a symbol to display status information of a sunroof. That is, in the present embodiment, the user can intuitively recognize the state of the sunroof without directly looking at the sunroof.

As described above, the present exemplary embodiment may improve the quality and marketability of a vehicle, further improve user convenience and vehicle safety, and secure product competitiveness.

What is claimed is:

1. A user interface, comprising:
a communicator configured to perform communication with a movable glass panel;
a display including a partial region in which a movable glass panel symbol image is displayed and a background region excluding the partial region;
an input configured to receive a touch input; and
a controller configured to:
recognize a location of a touch point touched on the input,
recognize a movement time, a movement direction, and a movement distance corresponding to the location change of the recognized touch point,
recognize the movable glass panel's closing degree information based on the recognized movement distance and the movement direction when the recognized movement time is more than a reference time,
change the display information of a background area displayed on the display based on the recognized movable glass panel closing degree information, and
control the communicator to transmit the recognized movable glass panel closing degree information to the movable glass panel.

2. The user interface according to claim 1, wherein the controller is configured to divide the background area into a first background area and a second background area based on the recognized movable glass panel closing degree information, adjust the size of the first background area and the second background area based on the recognized movable glass panel closing degree information, and change color information of the first background area.

3. The user interface according to claim 1, wherein the controller is configured to determine whether the movable glass panel is completely open based on the recognized movable glass panel closing degree, and change the color of the background area to a first color when it is determined that the movable glass panel is completely open.

4. The user interface according to claim 1, wherein the controller is configured to determine whether the movable glass panel is completely closed based on the recognized movable glass panel closing degree, and change the color of the background area to a second color when it is determined that the movable glass panel is completely closed.

5. The user terminal according to claim 1, wherein the controller is configured to change the color of the background area corresponding to an error condition when the movable glass panel opening/closing information is not received from the movable glass panel.

6. The user terminal according to claim 1, wherein the controller configured to change the display information of the movable glass panel symbol image in response to a state in which the movable glass panel is not completely open and closed and is jammed.

7. The user terminal according to claim 1, wherein the controller is configured to control the communicator to transmit a complete open command or a complete closing command based on the recognized movement direction when the recognized movement time is less than the reference time.

8. The user terminal according to claim 1, wherein the controller is configured to change the color of the background area to a first color when transmitting a complete open command to the movable glass panel, and change the color of the background area to a second color when transmitting a complete closing command to the movable glass panel.

9. The user terminal according to claim 1, wherein the controller is configured to acquire location information on which the movable glass panel symbol image will be displayed based on location information of the recognized touch point, control the display of the movable glass panel symbol image based on the obtained location information, and control the movable glass panel symbol image to be displayed at a reference location when a touch signal for the touch input is not received.

10. A vehicle comprising:
an opening/closing device including at least one of a movable glass panel and a window;
a display including a partial region in which a symbol image representing the movable glass panel is displayed and a background region excluding the partial region;
an input configured to receive a touch input;
a controller configured to:
recognize a location of a touch point touched on the input,
recognize a movement time, a movement direction, and a movement distance corresponding to the location change of the recognized touch point,
recognize the movable glass panel's or the window's closing degree information based on the recognized movement distance and the movement direction when the recognized movement time is more than a reference time,
change the display information of a background area displayed on the display based on the recognized movable glass panel closing degree information, and
transmit the recognized movable glass panel closing degree information to the opening/closing device; and
a driver configured to open or close the opening/closing device based on a control command from the controller.

11. The vehicle according to claim 10, wherein the controller is configured to divide the background area into a first background area and a second background area based on the recognized movable glass panel closing degree information, adjust the size of the first background area and the second background area based on the recognized movable glass panel closing degree information, and change color information of the first background area.

12. The vehicle according to claim 10, wherein the controller configured to determine whether the movable glass panel is completely open based on the recognized movable glass panel closing degree, and change the color of the background area to a first color when it is determined that the movable glass panel is completely open.

13. The vehicle according to claim 10, wherein the controller is configured to determine whether the movable glass panel is completely closed based on the recognized movable glass panel closing degree, and change the color of the background area to a second color when it is determined that the movable glass panel is completely closed.

14. The vehicle according to claim 10, wherein the controller is configured to change the color of the background area to a color corresponding to an error condition when the open/closed information of the recognized opening/closing device is not received.

15. The vehicle according to claim 10, wherein the controller is configured to change the display information of the symbol image in response to a state in which the movable glass panel is not completely open and closed and is jammed.

16. The vehicle according to claim 10, wherein the controller configured to transmit a complete open command or a complete closing command based on the recognized movement direction to the opening/closing device when the recognized movement time is less than the reference time.

17. The vehicle according to claim 10, wherein the controller is configured to change the color of the background area to a first color when transmitting a complete open command to the movable glass panel, and change the color of the background area to a second color when transmitting a complete closing command to the movable glass panel.

18. A control method of a vehicle having a movable glass panel, comprising:
recognizing a location of a touch point touched on an input;
recognizing a movement time, a movement direction, and a movement distance corresponding to the location change of the recognized touch point;
recognizing the movable glass panel's closing degree information based on the recognized movement distance and the movement direction when the recognized movement time is more than a reference time;
controlling the movable glass panel's closing degree based on the movable glass panel's closing degree information;
changing display information of a background area displayed on a display based on the recognized movable glass panel closing degree information, and
controlling the movable glass panel to be completely open or completely closed based on the recognized movement direction when the recognized movement time is less than the reference time based on the recognized movable glass panel closing degree information.

19. The method according to claim 18, wherein changing the display information of a background area includes:
changing the color of the background area to a first color when transmitting a complete open command to the movable glass panel,
changing the color of the background area to a second color when transmitting a complete closing command to the movable glass panel,
dividing the background area into a first background area and a second background area when the movable glass panel is partially closed, and adjusting the size of the first background area and the second background area based on the recognized movable glass panel closing degree information, and
changing the color of the first background area to a third color.

20. The method according to claim 18, further comprising:
changing the display information of the movable glass panel symbol image in response to a state in which the movable glass panel is not completely open and closed and is jammed.
